(19) United States
(12) Patent Application Publication
(10) Pub. No.: US 2006/0074839 A1
(43) Pub. Date: Apr. 6, 2006

(54) Merger integration analysis tool

(75) Inventors: William Pursche, Marshall, VA (US); Kristin L. Ficery, Atlanta, GA (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 10/948,738

(22) Filed: Sep. 24, 2004

(51) Int. Cl. G06F 17/30

(52) U.S. Cl. 707/1

(57) ABSTRACT

Disclosed are tools and related methods for performing analyses of the prospects for success of two or more companies that are anticipating undergoing a merger integration and/or the extent of current progress toward success of two or more companies that are undergoing such a merger integration. The present invention utilizes templates to produce scorecards, and preferred embodiments utilize electronic tools for facilitating data gathering and information organizing to assist merger managers in making findings regarding the relative success or failure of important merger integration guideposts, and for providing constructive feedback relevant to those findings.

### FIELD OF THE INVENTION

The present invention relates to a system and related methods for performing analyses of the prospects for success of two or more companies that are anticipating undergoing a merger integration and/or the extent of current progress toward success of two or more companies that are undergoing such a merger integration. More particularly, the present invention pertains to scorecards and electronic tools for facilitating data gathering and information organizing to assist merger managers in making findings regarding the relative success or failure of important merger integration guideposts, and for providing constructive feedback relevant to those findings.

### BACKGROUND OF THE INVENTION

In our modern market economies, many companies have tried to maintain or enhance profitability by focusing upon finding synergies that can be obtained by acquiring or merging with or by alliances with other companies. These synergies, for example, could result from cost reduction provided by eliminating duplication of resources, economies of scale or vertical and horizontal integration. Business mergers are therefore becoming increasingly more frequent occurrences in many markets and industries. Such mergers are becoming more and more complex with the involved companies being large and diverse, and often much of their fiscal health and growth upon the success of the merger. Success of the merger is thus of paramount importance.

Many businesses turn to external consulting firms or other specialists to evaluate proposed mergers, to assist in planning activities in an upcoming scheduled merger, and to manage the transition period for an ongoing merger. Much must happen in a relatively short time period for a merger to proceed successfully, including the merging of organizations, cultures, and technologies, and the elimination of redundant resources. The best elements from each of the original companies must be maintained, even as new elements needed by the resulting merged company are established. An experienced consulting firm or other organization of specialists advantageously brings to bear its pooled expertise and best practice knowledge with regard to these merger-related (or acquisition-related) changes. While one or more of the managers of the merging companies may have experience regarding a few prior mergers, the more experienced specialists may have the benefit of working on more total mergers than the combined experiences of all the managers of the merging companies. Thus, specialist firms are able to capitalize upon their wider scope of past experience and specific knowledge regarding the lifecycle of mergers, utilizing knowledge of commonly encountered problems and pitfalls, guideposts for tracking progress, and ways to solve problems and avoid pitfalls to more efficiently direct the merging companies to meet the ultimate business objectives underlying the merger.

While specialists can be hired at the pre-merger stage (i.e., during negotiations or prior to a deal being announced publicly), oftentimes, specialists are hired into a post-merger situation to manage a merger after the companies have already signed contracts and announced the merger, and sometimes even after various post-merger integration steps have been taken. When a particular specialist or specialist organization is brought into a merger situation after the pre-merger stage, they must be able to get a quick, yet accurate snapshot assessment regarding where the merging company stands in the various tasks that should be completed by the merger integration process. Only after getting an accurate snapshot can the specialists utilize their personal experiences and expertise to advise the client companies how to improve their post-merger integration efforts. Further, specialists, regardless of whether the become involved at the beginning of merger negotiations or at a later post-merger stage, will need to keep track of the integration's progress on an ongoing basis. Thus, in order to make the business relationship between the specialist and the merging companies successful, the specialist organizations must have the capability to assess the progress of the merger efficiently and accurately at various times within the merger lifecycle.

The management of post-merger integration can be heavily dependent upon the personal knowledge of the involved specialists. While a particular “lead” specialist within a specialist organization may be very knowledgeable regarding particular areas of post-merger integration, that particular specialist will likely not be able to perform a complete and accurate assessment in a quick manner on their own. These lead specialists typically enlist additional personnel resources from their organization, usually in the form of a team of less experienced specialists that will work under the direction of the lead specialist. These team members are often given the tasks of information gathering and sorting, such as by contacting and interviewing employees of the merging companies and obtaining, reviewing and organizing records relevant to post-merger integration activities. These can be complicated as progress assessments are often necessary at various times during a merger integration. Notably, merger integrations generally evolve according to a life cycle of different phases, characterized by different goals, tasks and activities. Thus, certain types of information may only be relevant to (or more relevant to) making progress assessments during one phase of a post-merger integration while less relevant or irrelevant to making progress assessments undertaken at other stages or phases of the integration. The team members therefore need direction regarding what information to seek at a particular time and from what sources to seek that information.

Since a specialist organization's worth to merging companies lies in the collective experiences and knowledge capital of its various individual specialists, it is important for those organizations to leverage this past experience and knowledge effectively by disseminating it to other specialists within the same organization. Only then can this knowledge and experience be utilized fully in the progress assessments of various mergers by many specialists within the organization in a manner that enables teams to perform the assessments as quick, economical, consistent, and accurate as is possible. Thus, in order to make the business relationship between the specialist and the merging companies successful, there also is a need for the specialist organization to have mechanisms for effectively sharing the knowledge and experience of lead specialists with their team members. Such sharing allows the specialist organization to be certain to obtain and analyze the most relevant information needed to perform a particular progress assessment and thereby identify those important post-merger activities and tasks that require attention.

Therefore, there is a need for improved mechanisms for assessing the relative progress associated with a successful integration of two or more companies where those mechanisms overcome the inherent difficulties in performing detailed yet quick progress assessments of a particular a post-merger integration. A mechanism that directs members of the specialist team to acquire the necessary information from the proper sources at the appropriate times during a merger or acquisition integration (henceforth, collectively referred to as “merger integration”) would greatly simplify the task of performing the various progress assessments during the integration and would therefore allow such assessments to be utilized regularly. Further, mechanisms for organizing and sorting the collected information for critical review of the progress in particular activities and tasks of interest undertaken during a given phase of the post-merger integration life cycle would also simplify the task of performing a meaningful review of that collected information. Likewise, a mechanism that identifies problem areas in the integration and associates those problems with suitable remedial or corrective actions to be taken to improve the situation of the merger in those areas would be beneficial.

### SUMMARY OF THE INVENTION

In light of the problems attendant in performing progress assessments of planned or ongoing merger integration efforts, it is an object of one or more embodiments of the present invention to provide tools and related methods that are adapted to provide a progress assessment of the relative quality and/or extent of success of planned or in-progress activities associated with an anticipated or ongoing merger integration efforts.

Additionally, it is an object of one or more embodiments of the present invention to provide tools and related methods that speed up and streamline the processes for performing a progress assessment for a merger so that assessments can be more easily performed on a regular basis.

Also, it is an object of one or more embodiments of the present invention to provide tools and related methods that enable members of a specialist organization to draw upon the collective experience of its various employees to determine how well a particular integration stacks up against prior integrations.

Further, it is an object of the present invention to provide assessment tools and related methods that save time, improve consistency, and provide access to the cumulative knowledge of a specialist organization, such as a consulting firm, relating to the planning and implementation of activities for post-merger integration. Optimally, such tools and related methods are capable of dramatically improving the ability of the specialist organization to identify problem areas arising in a merger integration quickly, and capable of assisting the ability to recommend potential remedial measures based upon collective and specific past experiences of the specialist organization.

It is another object of one or more embodiments of the present invention to provide an electronic tool that serves as a repository of information regarding how far a merger integration should have progressed at certain times in the merger life cycle, what the best practices are for particular merger integration activities, how to gauge progress for the particular merger integration activities, and what the merging organization should do if it is behind in one or more of those activities.

Similarly, it is an object of one or more embodiments of the present invention to provide an electronic tool that assists in identifying and reporting areas of poor performance for a merger integration and provides links to specific recommendations to remedial measures to improve the integration planning or process.

Furthermore, it is an object of one or more embodiments of the present invention to provide an electronic tool that directs members of the specialist team to acquire the necessary information from the proper sources at the appropriate times during a merger integration.

Likewise, it is an object of one or more embodiments of the present invention to provide an electronic tool that can be updated to reflect advances or changes to the most current best practices and knowledge of a specialist organization by modular adding of appropriate templates, tables, and interview forms as necessary or desired.

In response to these and other needs, the various embodiments of the present invention provide tools and related methods for assisting a user, such as a specialist or member of a merger integration team, in performing progress assessments to benchmark the status of planned or ongoing merger integration efforts. Assessment tools according to embodiments of the present invention prepare progress assessments by utilizing data collection, organization, review and analysis mechanisms that reflect the compiled knowledge of one or more experienced specialists regarding the various activities that must be undertaken during various phases of the post-merger integration life cycle. The progress assessments prepared provide relatively quick diagnostic scorecards to management of the merger integration efforts, which scorecards gauge how well the merger integration efforts are working to make the merger integration successful.

According to embodiments of the present invention, different scorecard templates can be used to prepare diagnostic scorecards at various times of a merger integration effort, such as during the different constituent phases of a post-merger integration life cycle, which phases may include a plan and launch phase, an integration program phase, a near term realization phase, and a skill building and complex issue resolution phase. A corresponding one of the scorecard templates is utilized to perform a given progress assessment depending upon the time within the life cycle of a merger integration during which that progress assessment is being performed. These different scorecard templates each reflect a plurality of integration activities that must be addressed during the corresponding phase of the merger integration life cycle, as well scoring criteria associated with the integration activities for judging how successful the current integration efforts to date have been at addressing each activity in a satisfactory manner. Optionally, to provide more detail in the analysis, each integration activity can be broken down further into two or more tasks that reflect underlying goals or results that fall under a given activity. The tasks would likewise be associated with scoring criteria for gauging relative success in addressing each task.

In some preferred embodiments of the present invention, at least two different scorecard templates are available, with one being customized for use during the plan and launch phase (or any equivalent pre or post announcement phase) of post-merger integration and a second being customized for use during the integration program phase of post-merger integration optionally, a third scorecard template can be provided in this preferred embodiment, with the third scorecard template being customized for use during the pre-merger stage of merger related activities.

In additional preferred embodiments of the present invention, each scorecard template comprises various activity scoring tables, each corresponding to one of the integration activities that should be performed during the phase in question. Each activity scoring table has a first axis, defining the tasks that underlie the particular activity, and a second axis, defining scoring levels that reflect judgments regarding the level of success reached by the current integration efforts at completing each such task. Preferably, each table defines four scoring levels, corresponding qualitatively to judgments of below average progress, average progress, above average progress, and best in class (or exceptional) progress. Also preferably, each table includes a plurality of tasks that underlie an integration activity for the post-merger phase in question. The various scoring criteria are oriented within the tables as corresponding to a particular scoring level and task, and provide a description of quantitative or qualitative indicators that assist in the user in identifying an appropriate scoring level that reflects the progress achieved for each task. The descriptions provided by the scoring criteria thereby reflect in simplified table format progress judgments in light of industry and/or business standards as determined by the collective expertise of one or more specialists with experience in monitoring and managing post-merger integration efforts.

A user of an assessment tool according to methods of the present invention can obtain information and data regarding the integration efforts, such as by interviewing various managers and/or knowledgeable workers associated with the merged organization or by reviewing data or documentation regarding the merged organization, and identify the scoring criteria within each table on the appropriate scorecard template that most closely matches or describes the collected information and data. A scoring level for each task, and then each activity, can thereby be obtained producing a compiled scorecard for that progress assessment. Activities having low score levels, such as “unsatisfactory progress,” can thereafter be identified for further analysis, and scorecard summary reports of the findings can be generated. The scorecard summary reports optionally can identify remedial measures that can be taken to improve upon the progress in one or more particular activities found to be demonstrating below average progress.

Also preferably, a database of best practices guidelines compiled from the knowledge of the specialists can be associated with various tasks identified in the scorecard templates, which guidelines can include instructive narratives providing suggestions on how to improve progress in completing certain tasks in a satisfactory manner, and optionally describing potential pitfalls experienced in trying to complete those tasks. The narratives optionally could include one or more relevant case studies illustrating prior post-merger integration situations relevant to addressing that task. The compiled best practices guidelines can thereby be accessed and reviewed by the persons performing a progress assessment, and used to compile the scorecard summary reports.

Preferred embodiments of the present invention include an electronic assessment tool, which includes software-driven applications and modules that provide linked forms, tables and databases to facilitate the methods of the present invention. The electronic assessment tool according to embodiments of the invention includes a database of scorecard templates containing the activity scoring tables, and preferably, a best practice guidelines database containing narrative records associated with the activity scoring tables.

The electronic assessment tool according to such preferred embodiments of the present invention also includes a scorecard generation module that allows the user to select an appropriate one of the stored scorecard templates, and then navigate through and review the scoring criteria and other contents of each scorecard template. The user can utilize the templates to select an appropriate one of the scoring levels for various tasks after comparing relevant information and data, obtained from interviews and the like, with the scoring criteria contained in the appropriate activity scoring table. The scorecard generation module is thereby adapted to automatically generate scorecards of various levels of detail reflecting the selected scoring levels, and, optionally, assist in the preparation of reports of the scorecards. Such reports can reflect details from the narrative records associated with certain tasks that have undesirable scoring levels, and, preferably, summary reports can be produced that include recommendations of remedial measures that can be taken to improve upon the progress in those tasks.

In some additional preferred embodiments of the present invention, the electronic assessment tool further includes an interview module that assists users in obtaining and organizing information from the merged organization. The interview module of the assessment tool includes a plurality of interview forms adapted to accumulate information relevant to performing a progress assessment. A database of such forms are provided, with each form being customized according to a type or category of target person to be interviewed and according to the particular phase of the merger integration life cycle, or time frame, during which the progress assessment is being undertaken. Each form contains questions, which questions can require open-ended qualitative answers or quantitative answers, or can require that answers be selected from multiple provided choices. The questions for each particular form are drafted to elicit the type information from the target person that would be useful in performing the progress assessment in that post-merger integration phase. Each question presented on each interview form is associated with one or more tasks contained in the activity scoring tables, where each question is expected to obtain information relevant to evaluating the scoring criteria for the particular associated tasks.

Responses to the questions on the forms can thereafter be input into the electronic assessment tool using the interview module, and the cumulative responses from various interviews can be accumulated, attributed and organized into relevant portions of a detailed scorecard by the scorecard generation module for review by the user. The user can then review this detailed scorecard to see an overview of collected and organized information potentially relevant to each integration activity and task, and more easily consider the scoring criteria for each task. Summary scorecards containing finalized scores for the activities and tasks can be generated as desired using the information contained in the scorecards.

As described herein, the tools and related methods of the present invention provide the persons who mange a post-merger integration with the ability to quickly obtain, assemble and consider information and use that information to prepare a detailed progress assessment describing the relative success of the current integration efforts in addressing integration activities. The software-driven applications and modules of the preferred embodiments substantially expedite the collection of information and preparation of detailed and summary reports to make progress assessments more useful by making the process of preparing them less time consuming and thus more readily utilized.

The various features of the invention having thus been described, preferred embodiments thereof will hereafter be described in detail with respect to several drawings.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 is a schematic diagram of the timeline of the pre-merger and post-merger stages for a merger deal, which depicts the repeated use of various progress assessments according to embodiments of the present invention;

FIG. 2 is an illustration depicting a user view of a an electronic assessment tool for navigating among scorecard templates, forms, reports and the like in accordance with embodiments of the present invention;

FIG. 3A and FIG. 3B are illustrations depicting user views of a page of accessing and reviewing activity scoring tables for a scorecard template with an electronic assessment tool in accordance with embodiments of the present invention;

FIG. 4 is an illustration depicting a user view of an interface for accessing a detailed scorecard with an electronic assessment tool in accordance with embodiments of the present invention;

FIG. 5 is an illustration depicting a user view of an interface for accessing and creating a summary scorecard within an electronic assessment tool in accordance with embodiments of the present invention;

FIG. 6 is an illustration depicting a user view of a page for accessing a narrative record from a database of best practices guidelines with an electronic assessment tool according to preferred embodiments of the present invention;

FIG. 7 is an illustration depicting a user view of a interview form selection interface provided by an electronic assessment tool according to preferred embodiments of the present invention;

FIG. 8 is an illustration depicting a user view of a sample interview form provided by an electronic assessment tool according to preferred embodiments of the present invention; and

FIG. 9 is a schematic diagram of a system supporting an electronic assessment tool according to one embodiment of the present invention.

### DETAILED DESCRIPTION OF THE PREFERRED EMBODIMENTS

Embodiments of the present invention as described herein enable managers of a merger integration to collect, organize, review and analyze information and data relevant to a merger integration assessment in a facilitated manner. The various embodiments of the present invention provide tools and related methods, and preferably electronic tools, that utilize different scorecard templates for the different constituent phases of a post-merger integration life cycle, with the different templates reflecting the underlying substantive differences of each phase and enabling the performance of progress assessments successfully and rapidly during each phase. Preferably, different scorecard templates are provided for at least the plan and launch phase and the integration program phase. Optionally, additionally scorecard templates can be provided for one or both of the near term realization and skill building and complex issue resolution phases. Also optionally, the plan and launch phase scorecard template can be utilized during the pre-merger stage in a prospective manner, or alternatively a separate pre-merger stage scorecard template can also be provided. Each scorecard template can be utilized according to the present invention to perform a given progress assessment during the particular phase within the life cycle of a merger integration to which that template corresponds.

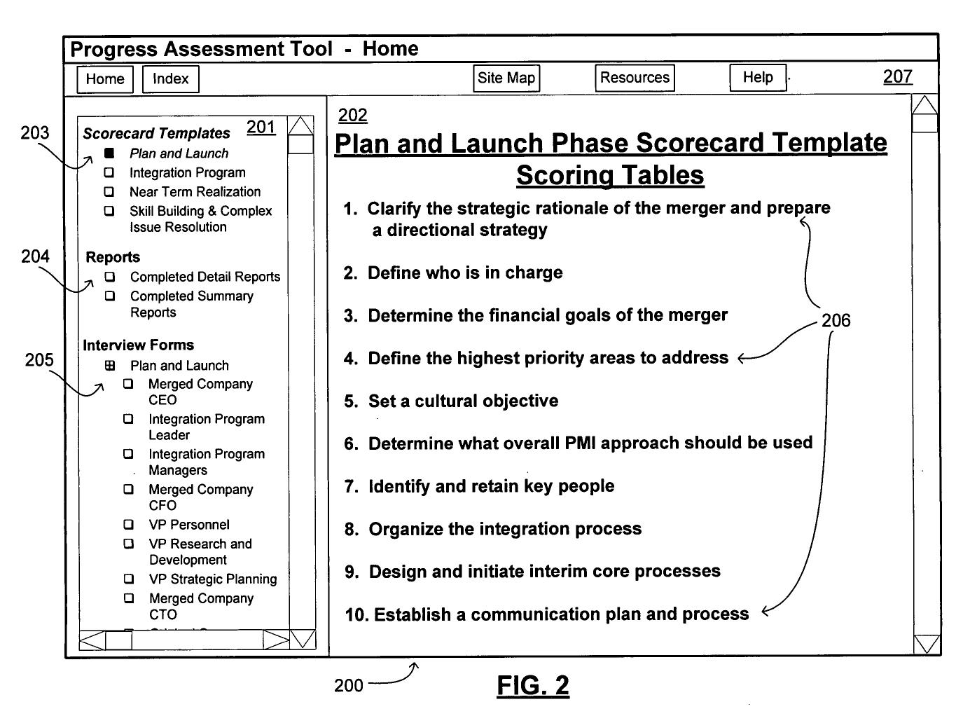

The different scorecard templates each reflect a plurality of integration activities that must be addressed during the corresponding phase of the merger integration life cycle, as well scoring criteria associated with the integration activities for judging how successful the current integration efforts to date have been at addressing each activity in a satisfactory manner. As discussed further below, FIG. 2 provides a listing of various integration activities that can be identified within the plan and launch phase of post-merger integration. According to the present preferred embodiment, each integration activity is broken down further into two or more tasks that reflect underlying goals or results that fall under a given activity so as to provide the ability to increase depth in the assessment. The tasks under each integration activity are associated with scoring criteria for gauging relative success in addressing each task.

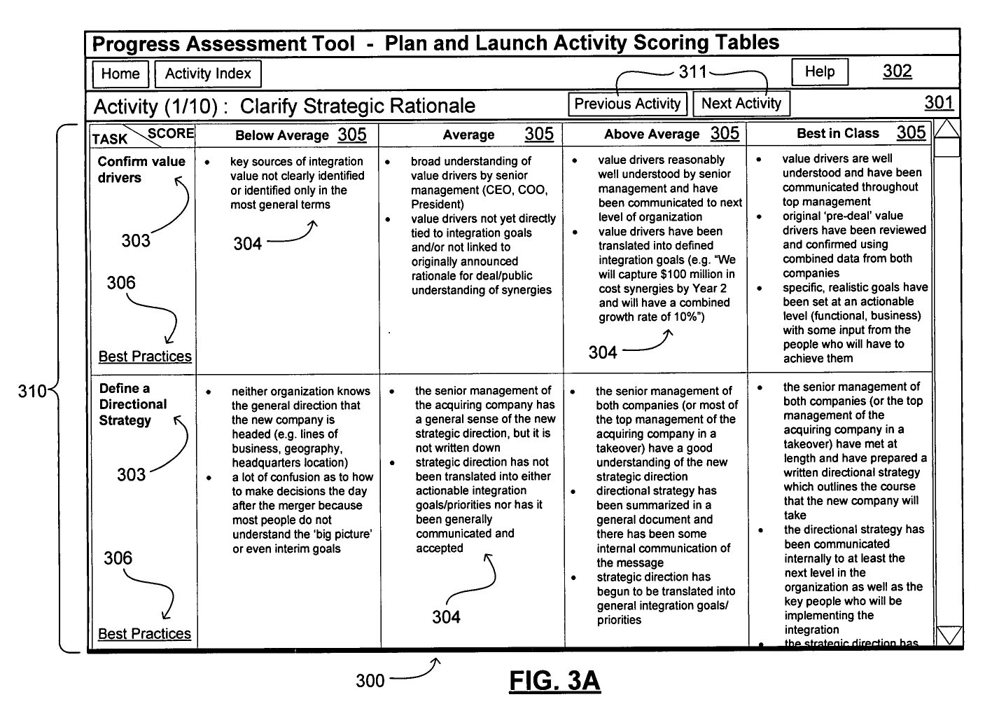

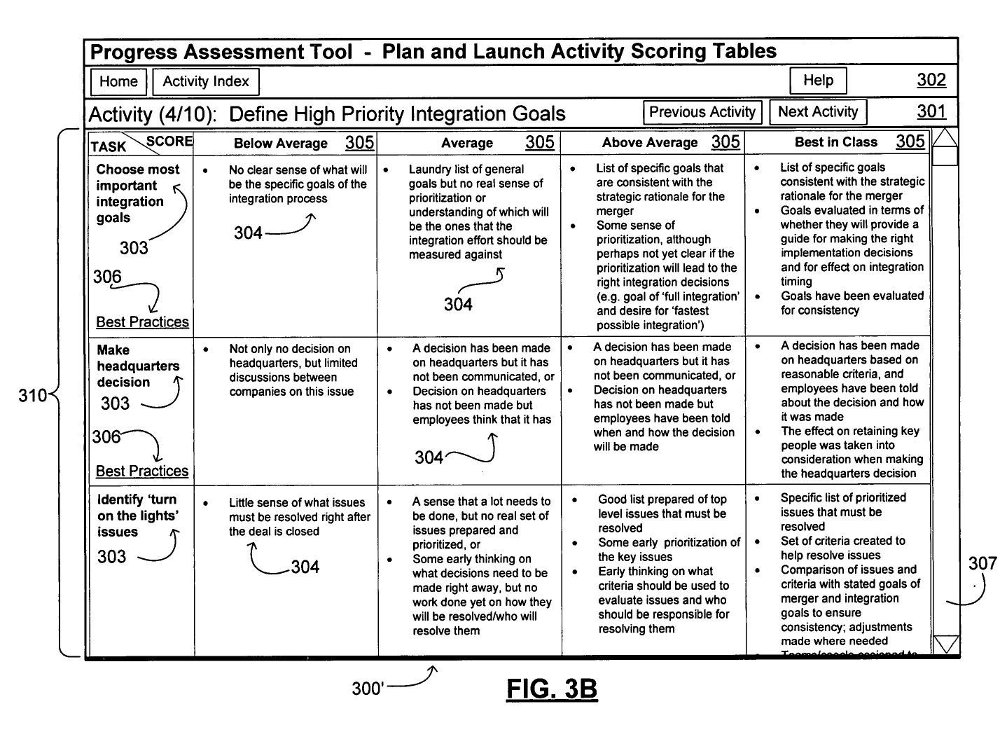

A scorecard template according to preferred embodiments of the present invention comprises various activity scoring tables, each table corresponding to one of the integration activities falling within the corresponding integration phase. An example of a scorecard template as utilized within an electronic tool according to one preferred embodiment of the present invention is depicted in FIG. 3A and FIG. 3B (each depicting a different table within a given scorecard template), as discussed below. Each activity scoring table has a first axis, defining the tasks that underlie the particular activity, and a second axis, defining scoring levels that reflect judgments regarding the level of success reached by the current integration efforts in completing each such task. Preferably, each table defines four scoring levels, corresponding qualitatively to judgments of below average progress, average progress, above average progress, and best in class (or exceptional) progress. Also preferably, each table includes a plurality of tasks that underlie a particular integration activity for the post-merger phase in question. The various scoring criteria are oriented within the tables as corresponding to a particular scoring level and task, and provide a description of one or more quantitative or qualitative indicators that assist in the user in identifying an appropriate scoring level that reflects the progress achieved for that task. The descriptions provided by the scoring criteria thereby reflect in simplified table format progress judgments with respect to industry standards as determined by the collective expertise of one or more specialists with experience in monitoring and managing post-merger integration efforts.

Methods according to embodiments of the present invention perform progress assessments utilizing the scorecard templates by assisting in the collection of data and information relevant to activities detailed on the scorecard template for the particular phase of the integration. A user could utilize a scorecard template according to methods of the present invention to identify and then obtain information regarding the integration efforts, such as by interviewing various managers and/or knowledgeable workers associated with the merged organization or by reviewing data or documentation regarding the merged organization. Each piece of the obtained information and data would then be organized with regard to its relevance to one or more of the integration activities and tasks in the tables. The relevant organized information and data is then compared to the scoring criteria laid out within the scorecard template tables, and a user can thereby identify the scoring criteria within each table on the appropriate scorecard template that most closely matches or describes conclusions based upon the relevant information and data. A scoring level for each task, and then each activity, can thereby be obtained, and a compilation of these scoring decisions thereby produces a compiled scorecard for the progress assessment.

Methods according to the present invention can further include analyzing the information and data in light of the compiled knowledge of one or more experienced specialists as reflected in the scorecard templates to identify actions that can improve merger integration performance. Activities having low score levels, such as “unsatisfactory progress,” can thereafter be singled out for further analysis, and scorecard summary reports of the findings can be generated. The scorecard summary reports optionally can identify remedial measures (e.g., taken from a database of relevant narrative records as described below) that can be taken to improve upon the progress in particular activities demonstrating below average progress. In this manner, a user is provided with a substantially simplified way to perform relatively quick progress assessments that in turn provide a useful diagnostic scorecard to management of the merger integration efforts, which scorecard gauges how well the merger integration efforts are working to make the merger integration successful.

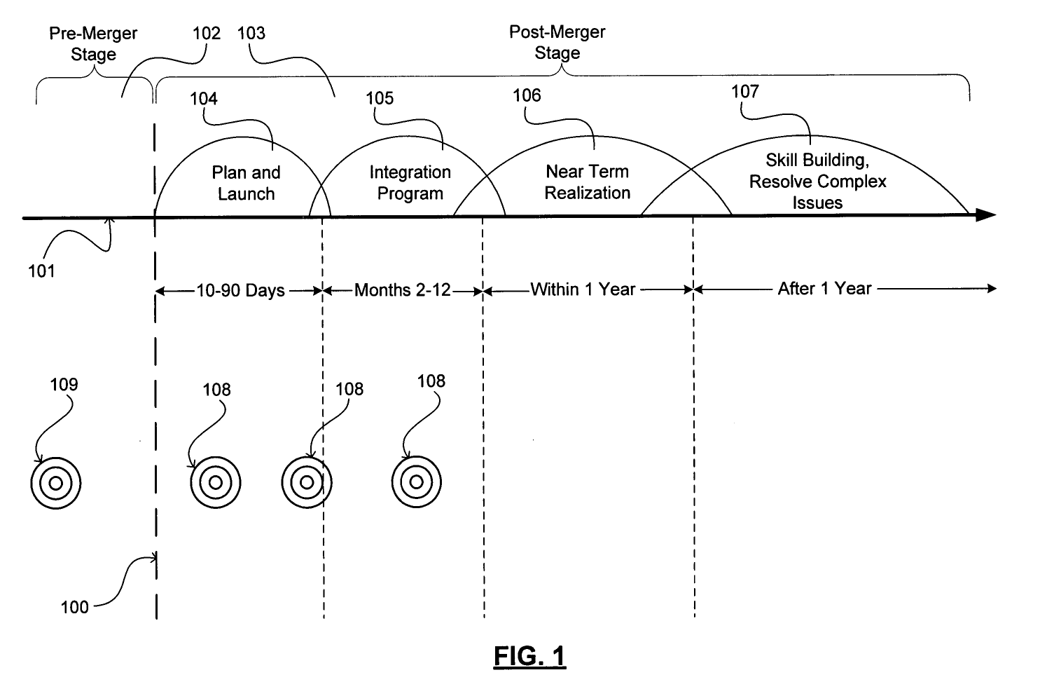

Embodiments of the invention can best be understood within the context of the particular nature of the needs of integration team leaders in a pre-merger integration planning or post-merger integration management setting. As depicted in the schematic diagram of FIG. 1, the merger of two companies or organizations can be thought of as progressing through a predictable merger integration life cycle as time progresses along timeline 101. For each merger, there is a pre-merger stage 102, which generally can be thought of as the time frame in which negotiations are taking place to establish the basic parameters of the merger, and a post-merger stage 103, which includes all the time after a decision or agreement to undergo a merger is made and during which post-merger integration activity takes place. In FIG. 1, the decision point to proceed with the merger in question is generally depicted as occurring at the point in time where dashed line 100 intersects timeline 101.

As shown in the drawing, the merger life cycle can be conceptualized further by breaking down the post-merger stage 103 into various overlapping constituent phases 104-107 of post-merger integration activity. One of ordinary skill in the art will recognize that FIG. 1 is just one possible conceptualization of the life cycle of a merger, and that many different conceptualizations can be adopted that use different terminology and division. It should be understood that the tools according to embodiments of the present invention can be readily adapted to any adopted framework consisting of related phases, activities and tasks as hereafter generally described. The first constituent phase immediately after the merger decision is made, as depicted in FIG. 1, is the plan and launch phase 104. During this time period, the managers in charge of the integration, which may typically include an implementation team selected from managers or executives from one or both pre-merger companies plus any hired specialists, would typically construct the top level goals and post-merger integration plan. For example, these would generally include: deciding upon any top-level organizational decisions, including adopting an anticipated organizational and leadership structure, financial targets, and cultural and strategic objectives. As detailed in FIG. 1, the plan and launch phase 104 is the immediate period after a post-merger integration begins, and its underlying integration activities usually span a period of about 10 days to about 90 days after a merger deal has closed. This phase, because various high level and far reaching decisions are made and put into action, largely impacts the success of activities undertaken in subsequent phases of post-merger integration. Thus, it is important to get decisions and activities in the planning phase done (and done properly) as soon as possible. The short time frame within which plan and launch activities are performed, however, makes critical review during this phase difficult under normal circumstances. As described in detail below, the various tools of the present invention addresses these issues by substantially facilitating and speeding up the process of performing a progress assessment.

The next phase, the integration program phase 105, begins sometime after the plan and launch phase 104 and usually would span a period from about the second month to about the twelfth month after post-merger integration has begun. As depicted in the drawing, this second post-merger integration phase generally overlaps the first phase as there is typically no clear demarcation of a transition between the two phases. For example, activities begun sometime in the first phase can continue on and overlap with activities associated with the second phase (or even later phases). The integration program phase generally can be thought of as beginning the initial implementation of the merger integration plan. Activities that would be undertaken during this integration program phase would include, for example, combining business, financial, and IT systems, reorganizing sales territories, and streamlining operations.

The next phase as depicted in FIG. 1 is the near term realization phase 106, where the merging organization (the result of the two original companies post-merger, also referred to herein interchangeably as “merging company,” “merged organization,” or “merged company”) begins to capture the initial savings and benefits from the changes implemented in the prior phases. As depicted in the drawing, this phase greatly overlaps with the prior integration program phase 106 as it generally encompasses the entire period up to about a year after the merger integration was begun. At this point in the merger integration life cycle, management would typically begin to implement changes that were evaluated and assessed during the prior phases. In addition, effects of the merger implementation may begin to be realized, and these may be tracked as to whether initial expectations or projections are being met (or will be met) according to plan. Following the near term realization phase 106 is the skill building and complex issue resolution phase 107. The activities comprising this last phase would typically begin about one year after the post-merger integration is begun, and would include a transition of the merged organization into a more “normal” stage of operations for the resulting merged organization. At this time, the management of the merged organization would typically be less focused on completing its merger integration plan, and more focused rather on how to evolve, transform and improve upon the merged organization in order to fine tune day to day operations of the merged organization and otherwise improve upon or meet the end goals of the merger deal.

As will be readily appreciated by one skilled in the art, the different post-merger integration phases 104-107 have different characters because the activities undertaken during these phases serve different purposes and goals. The earlier phases of the life cycle are generally under pressure to progress at a much quicker pace as time consuming integration activities down the road can be held in abeyance while earlier activities are completed. Understandably, therefore, a higher density of integration activities usually take place near the beginning of the integration as opposed to 10 months or a year down the line. The present invention therefore serves a need, especially in the earlier phases of post-merger integration, to provide progress assessment mechanisms that can take place quickly, yet give accurate and constructive feedback regarding where the integration effort is versus where it should or could be.

In this regard, FIG. 1 depicts a series of scheduled progress assessment intervals 108 distributed at various times within the post-merger phase 103, which intervals illustrate the various times within the merger integration life cycle when it might particularly be useful for the integration team overseeing the integration efforts to get a snapshot summary of the extent of progress on and relative success of the various integration activities. The timing and spacing of the progress assessment intervals 108 can, of course, vary according to circumstances, as the integration team running a particular post-merger integration could desire feedback at various times. It is, however, preferred that at least one progress assessment interval 108 for performing a progress assessment according to the present invention be scheduled for the plan and launch phase, and more preferred that at least one progress assessment interval 108 be scheduled for each of phases 104 and 105 as these initial two phases would most largely benefit from a quick, yet thorough and accurate progress assessment of merger integration activities. The results of any particular progress assessment performed during any given interval 108 could then be used to determine whether, and, if so, when, additional assessments need to be undertaken (for example, to track improvement in one or more identified problem areas after remedial measures have been undertaken).

Notably, FIG. 1 does not depict scheduled progress assessment intervals 108 within phases 106 and 107. As described above, embodiments of the present invention are directed toward assisting merger integration team members in producing thorough and accurate progress assessments in a fast and simplified manner to provide feedback during the earlier and more critical phases of post-merger activity. Thus, the hereafter described preferred embodiments of the present invention are described in the context of use during the plan and launch phase and the integration program phase of post-merger activities. One of ordinary skill in the art, however, will readily appreciate that the features of the assessment tools as described hereafter can readily be adapted and extended to provide assessments and produce scorecards in the later phases of integration (such as by providing suitable scorecard templates and interview forms as hereafter described), if desired.

Still referring to FIG. 1, there also is depicted a prospective assessment interval 109 located within the pre-merger phase 102. The pre-merger phase 102 can be a period of intense negotiations leaving little time left available for managers of either company involved in the potential merger to allocate to performing an assessment regarding the expected details of the non-finalized merger. For example, there could be a situation where a two companies have been actively discussing a merger for some time, and where the deal is considered very likely proceed to fruition but for various reasons (such as waiting for FTC or SEC clearance) is not 100% finalized. The two companies in such a circumstance may have had, within permissible limits, some discussions about select planning and launch phase activities, such as selecting what the merged organization will look like and possibly have discussed what general steps will need to be taken to address any perceived integration issues. At the pre-merger stage, for instance, it is possible that both sides could have discussed where the merged organization's headquarters would be located, an anticipated management structure, and a broad integration timeline. At this pre-merger time, it could be beneficial for managers to be able to get a snapshot assessment of where they stand for “peace of mind” and make sure no major issues are being neglected. Notably, the managers would be more likely to be open to having such an assessment done if it was only marginally intrusive of to their personal time and the resources allocated to the deal negotiation. Embodiments of the present invention as described in detail below also serve to fulfill this need.

Referring now to FIG. 2, there is illustrated a user view 200 produced by an electronic assessment tool according to a preferred embodiment of the present invention, which user view 200 allows a user to navigate within the tool among scorecard template review, and scorecard generating and reporting functionality. As shown in FIG. 2, a first user view of the progress assessment tool provides a navigation homepage 200 interface for the user to access various features of the electronic tool. The navigation homepage 200 is broken into two primary windows, a navigation window 201 and a display window 201. As is known in the art, the interface also includes a navigation bar 207 located at the top of the navigation homepage 200, which bar can include various buttons or drop down menus (not shown) for directly accessing various data and/or features of the tool. Within the navigation window 201, the user is provided with various hyperlinks that would cause the display of appropriate information, or links to pages having the appropriate information, within the display window 202. These hyperlinks can be grouped as appropriate under section headings such as scorecard templates 203, scorecards 204, and interview forms 205, as is shown, and, optionally, best practices narratives (not depicted).

In the particular navigation page 200 depicted in FIG. 2, the “Plan and Launch” hyperlink listed underneath the heading scorecard templates 203 has been selected by the user, leading to the display within the display window 202 of a listing of the activity tables for the various integration activities within the plan and launch phase's scorecard template. In the illustrative embodiment depicted, table links 206 identify and provide access to tables for the ten integration activities that are currently defined by the appropriate scorecard template as falling within the plan and launch phase. As will be readily appreciated by one of ordinary skill in the art, these ten integration activities are not necessarily represented within FIG. 2 as being in any particular order. While the first four identified integration activities, for example, may typically be addressed earlier within the plan and launch phase, it is not uncommon for many plan and launch integration activities, or integration activities in any phase, to be undertaken in parallel. The activities identified in FIG. 2 are intended to be exemplary in nature.

Navigation homepage 200 provides the user with the ability to navigate within the progress assessment tool to review the activities and access the tables for individual scorecard templates. By accessing the tables for a particular scorecard template, users can utilize the assessment tool to review scoring criteria representative of cumulative knowledge and to compile scorecards for a particular progress assessment. For example, by navigating to the plan and launch scorecard templates as described above, and then clicking upon or otherwise selecting the first table link 206 from the list in the display window 202, the user could be provided with a user view of a plan and launch activity scoring table 310 relating to the activity “Clarify Strategic Rationale,” as is depicted in FIG. 3A.

Referring now to FIG. 3A, a user view of an activity scoring table page 300 provides identifier information at its top so the user can readily identify that the table accessed via that page relates to the plan and launch phase (“Plan and Launch Activity Scoring Tables”), and information provided on activity bar 301 identifies that the currently displayed table relates to the first activity of ten (“Activity (1/10): Clarify Strategic Rationale”) for that particular scorecard template. The lower portion of the page 300 provides the user with a view of the stored activity scoring table 310 relating to the identified activity as defined by the plan and launch scorecard template. A navigation bar 302 is provided near the top of the page 300, which may include various navigation buttons, drop down menus (not depicted) or help features as is known in the art. Further, activity bar 301 as depicted can include navigation features, such as buttons 311, that allow the user to directly navigate to other activity scoring tables corresponding to other activities defined by the currently selected scorecard template (i.e., without having to navigate back to homepage 200).

The majority of the page 300 as depicted in FIG. 3A comprises a display of the activity scoring table 310 for the integration activity “Clarify Strategic Rationale.” Along the far left side, the table 310 includes a first column that identifies the tasks 303 which underlie the particular activity (in this case, two tasks), and the balance of the table comprises four additional columns 305 corresponding to four different scoring levels for each task. As depicted in FIG. 3A, the scoring levels, going from left to right in the table 310, include “Below Average,” “Average,” “Above Average,” and “Best in Class,” corresponding to the scoring levels as described above. The eight grid locations corresponding to the intersection of the rows defined by tasks 303 and four scoring level columns 305 contain various scoring criteria entries 304 relating to each task and scoring level combination. Each combination of task and scoring level has different listing of scoring criteria, with that scoring criteria having been derived from the compiled cumulative knowledge of experienced specialists. This scoring criteria is crafted to provide a specialist performing a given progress assessment with guidance in grading the relative success of the integration activities to-date in completing the particular task in question. A user of the assessment tool according to the present invention can review the table for any particular activity that falls within the scorecard template for a desired post-merger integration phase, and thereby easily obtain criteria for determining how successful an organization's integration efforts have been at successfully addressing the underlying tasks of the activity.

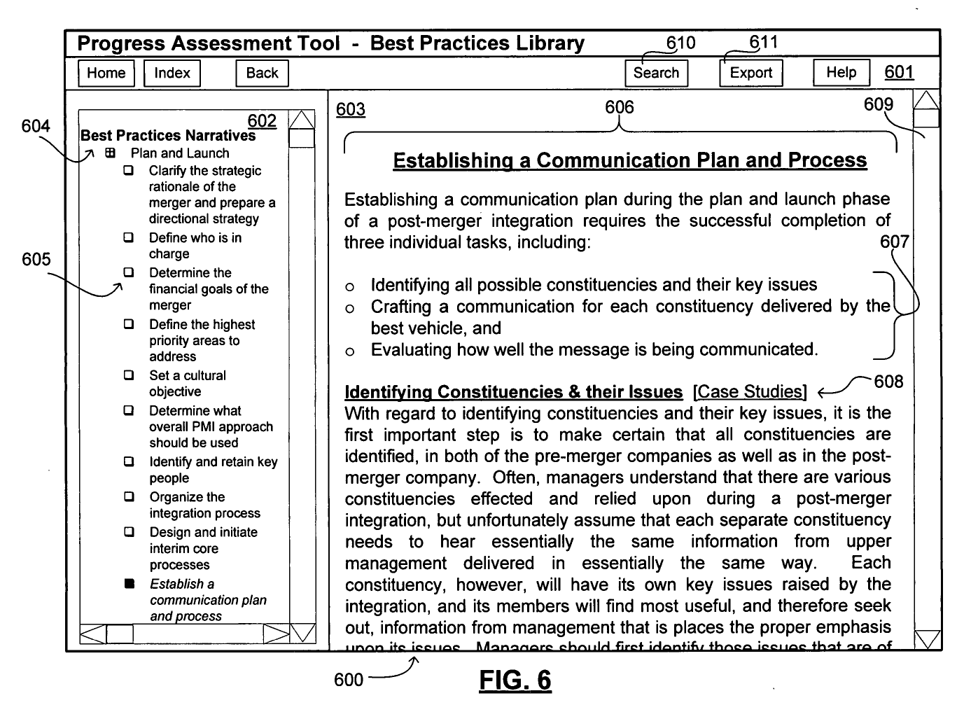

Also as depicted in FIG. 3A, page 300 provides hyperlinks 306 that are adapted to redirect the user to relevant narrative entries within a database of narrative records that describe industry established or expert recommended best practices for successfully addressing the various integration activities identified in the various scorecard templates. Such best practices narratives are described in further detail below with respect to FIG. 6.

FIG. 3B depicts a second user view of an activity scoring page 300′ showing the display of a different activity scoring table 310′. As depicted, page 300′ pertains to the fourth activity out of ten total for the selected scorecard template, corresponding to the activity “Define High Priority Integration Goals” (a link to this activity scoring table also being depicted in the navigation page 200 of FIG. 2). This activity scoring table page 300′ could, for example, be reached by navigating via the appropriate table link 206 from the list in the display window 202, or by using the particular one of navigations buttons 311 labeled “Next Activity” in task bar 301 from a prior activity scoring table or utilizing the button “Previous Activity” labeled one of buttons 311 from a subsequent activity scoring table. Notably, the particular activity scoring table 310′ illustrated in page 300′ contains three identified tasks 303 in the column along the left side of the table. As such information may not readily fit on a page that is viewable all at once, the user could review the scoring criteria 304 for all three tasks by using the scroll bar 307 located along the right side of the page 300′ as is known in the art. In this manner, a single user view can be employed for each activity scoring table in order to make navigation more intuitive. Comparison of tables 310 and 310′ illustrates that the scoring tables for various activities can contain any number of scoring criteria 304 for each combination of task and scoring level. The scoring criteria can, depending upon the tasks in question, include qualitative conclusions drawn from information obtained from managers or directors of the merged organization, qualitative markers which can be used to identify desirable values for particular financial or business metrics, or combinations of both.

While the activity scoring tables 310 and 310′ as depicted in pages 300 and 300′ can be utilized according to the present invention in a manual fashion as described above (such as by printing them onto several sheets of paper for manual reference by a specialist), it is preferred that the electronic assessment tool according to the present invention also provide functionalities that assist a user in generating a scorecard using an appropriate one of the scorecard templates.

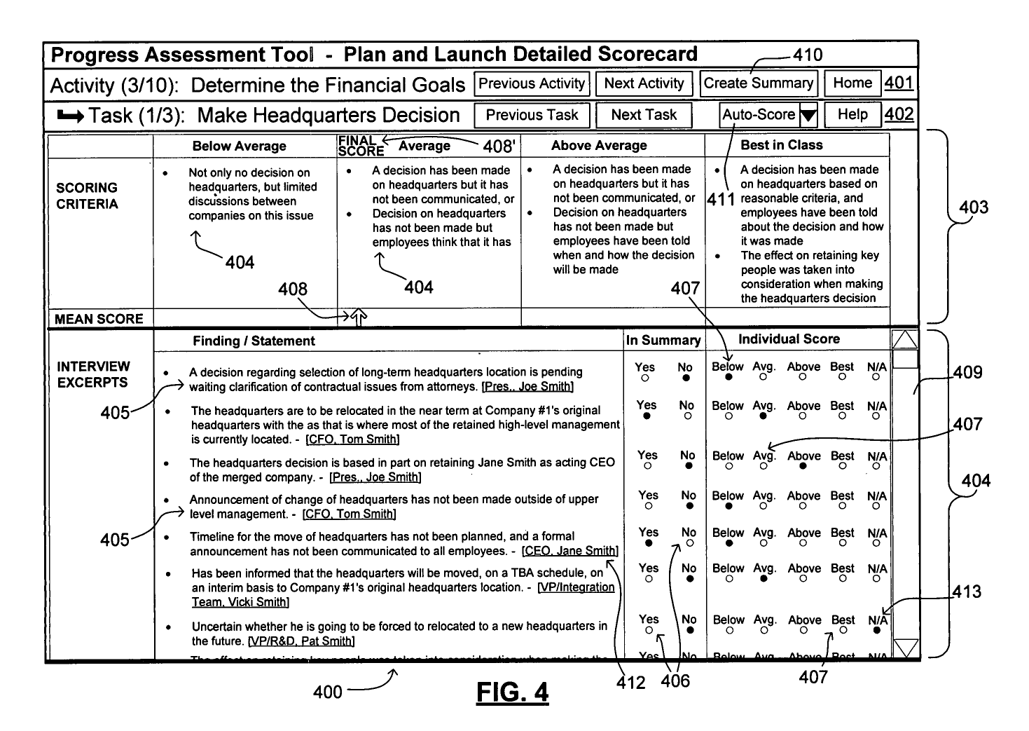

FIG. 4 illustrates a user view of a detailed scorecard page 400 produced by an electronic assessment tool according to a preferred embodiment of the present invention wherein a user may access, modify and create a detailed scorecard for a particular progress assessment. As depicted in FIG. 4, page 400 is broken into an upper window 403 and a lower window 404. At the top of the page 400 there is provided an activity bar 401 and a task bar 402 located beneath a page title identifying the view as a “Plan and Launch Detailed Scorecard.” The activity bar 401 identifies the particular page 400 as relating to the activity “Determine the Financial Goals,” and the activity bar includes buttons for navigation to previous and next activities within the plan and launch phase similar in manner to the buttons 311 present in pages 300 and 300′. Task bar 402 further identifies the page 400 as pertaining to the first of three illustrative tasks falling within that activity, namely the task “Make Headquarters Decision.” Task bar 402 also includes similar navigation buttons that allow the user to navigate to a previous task or a next task.

Upper window 403 includes a reproduction of the scoring criteria 404 associated with each of the four scoring levels for the task in question. Scoring criteria is provided in portion 403 (as opposed to being merely viewable via an appropriate activity scoring table page) in order to allow the user to easily compare any compiled information and data that is relevant to the progress in addressing that task successfully with the appropriate scoring criteria. This helps the used to determine the appropriate scoring level to represent the progress for that task.

As described above, a user of the progress assessment tool according to embodiments of the invention would accumulate information and data relevant to the various integration activities and their underlying tasks as itemized on the appropriate scorecard template. In preferred embodiments of the present invention, this information and data would be input into the progress assessment tool, such as by manually correlating the collected information and data with appropriate activities and tasks and entering that information and data into the tool (such as via appropriate electronic input or data entry forms or interfaces as is known in the art), or by using an automatic mechanism for correlating and inputting the information and data (as is described in more detail below with respect to electronic interview forms). This data and information is reproduced by the progress assessment tool within the lower window 404 of the appropriate detailed scorecard page 400 for any relevant activities and tasks. In this manner, the user can have all the relevant scoring criteria and all of the relevant information and data needed to assess which scoring criteria have been met for a task presented at once, thus simplifying the assigning of a scoring level for the task.

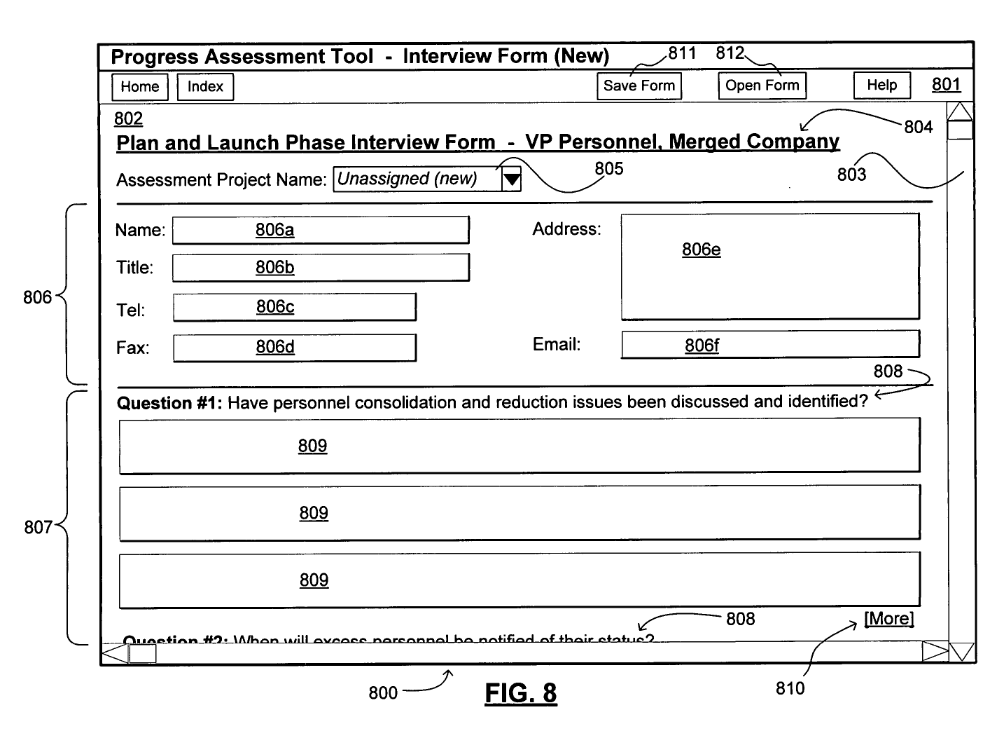

As illustrated in FIG. 4, the information and data obtained by those performing the progress assessment is organized in the progress assessment tool according to those activities and tasks for which the information and data will be relevant. For example, one suitable type of data and information input form for this purpose could allow a user to enter a statement or finding (such as a sentence or two describing a discrete item of interest to the progress assessment), indicate a source for that statement/finding (such as a person's name and title if it came from an interview, or a document or other source identifier), and then select one or more of the tasks (such as from a list) for which the statement/finding appears to have relevance. Preferably, as described below, automatic mechanisms are utilized to input, source and correlate statements and findings within the assessment tool. Once inputting of information and data is achieved, it is reproduced in the appropriate detailed scorecard, such as is depicted in page 400 by a listing of findings and statements entries 405 within lower window 404. Each entry 405 is attributed by the progress assessment tool to its source (such as to “CFO, Tom Smith”) with a hyperlink 412 providing a direct link that could describe the source of that information. As described further below with respect to FIG. 8, this hyperlink 412 preferably provides the user with a full view of the original source of the information. In particular, this source would preferably be the complete interview form for the particular person being interviewed (or a listing of all entries relevant to all tasks which are attributed to that source), or, in the case of non-interview documentation, an electronic scan of a suitable document, or a compilation of all statement and finding entries citing that person or source.

Upon reviewing a particular entry 405 as listed in window 404, and optionally reviewing any underlying source materials via hyperlink 412, the user could then assign an individual score relating to that finding or statement by clicking on an appropriate one of score selection circles 407 (four for each entry 405, corresponding to the four scoring levels) located in a column on the right side of window 404. As depicted, for example, an entry 405 comprising a statement by President Joe Smith indicating that a decision regarding the selection of a long term headquarters location is still pending while the executive committee waits clarification of contractual issues from its attorneys could be rated by the user of the assessment tool (after considering the scoring criteria 404 in upper window 403) as counting as a below average data point for accessing the overall score for the task in question. The user could make this scoring decision for this entry effective by clicking on the corresponding “Below” selection circle, in turn causing the circle to be darkened, as depicted optionally, the column containing the score selection circles 407 can also contain a selection circle 413 (labeled “N/A” in page 400) allowing the user to instruct the assessment tool to ignore that entry as being obsolete or irrelevant for that particular task.

Further, for each finding or statement, lower window 404 also provides a pair of selection circles 406 for each entry 405, which circles 406 could allow a particular finding or statement to be designated for inclusion in subsequently generated summary scorecards for the present progress assessment. In this manner, the tool could assist a user in not only assessing the relevance of each piece of data or information relating to the scoring of an activity or task, but also decide whether that particular finding or statement is of sufficient importance to be flagged for possible quotation or citation in any resulting reports. As depicted in FIG. 4, a user would review each finding or statement (a detailed scorecard page can have many entries of such) and then provide an individual score for each entry 405 using one of the selection circles 407 (or alternatively chose selection circle 413 to have that entry ignored), and then make a decision regarding whether that entry should be flagged for inclusion in subsequent summaries by choosing one of selection circles 406. A scroll bar 409 could be provided as necessary to allow the user to scroll within portion 404 in order to see and review each statement 405 relating to the task in question.

Further, the embodiment of the detailed scorecard page 400 as depicted illustrates the ability of the progress assessment tool to automatically generate an averaged or mean score for the task in question derived from the individual scores for each entry 405. When operating in an automatic scoring mode, the progress assessment tool would automatically slide scoring indicator 408 horizontally in an appropriate direction depending upon the mean value calculated from the individual scores assigned using selection circles 407 for each entry 405. This mean value, for example, can be calculated by assigning various relative numeric values to an individual score of Below Average, Average, Above Average, and Best in Class (such as −1, 0, 0.75 and 1.5, respectively) and ignoring all entries designated as being not applicable (“N/A”). This automated scoring average feature, for example, would be of particular use when there are many findings or statements relating to a particular task such that it would be difficult for the user to see at one time where all the individual scores appear to be falling. In the particular example depicted in FIG. 4, indicator 408 is showing that the mean score derived from all of the individual scores of the entries 405 falls closest to the “Average” scoring level, and is relatively closer to a “Below Average” mean score than an “Above Average” mean score (i.e., the mean score is on the lower end of average scores). The user could accept this automatically calculated mean score as the final assigned scoring level for a particular task in question, or the user could manually assign a final score via pull-down selection box 411 (which could provide available choices “Auto-Score,” “Below Average,” “Average,” “Above average,” and “Best in Class”). In operation, a user could proceed to review each individual statement or finding entry 405 in the lower window 404, assign an appropriate individual score, and then review the resulting mean score as automatically provided by indicator 408. At this point, the user could then use pull-down selection box 411 to assign manually whichever final score for the task that the user deems is appropriate. If selection window 411 is left as “Auto-Score,” then the final assigned score is the same as the mean score. The current assigned score at any time can optionally be indicated on page 400, such as by a notation 408′ within the upper window 403 as depicted.

Once a final score has been assigned for the task in question, the user can proceed to the next task and/or activity using the buttons on activity bar 401 or task bar 402 until all activities and tasks defined by the scorecard template in question have been addressed. At this time, the user could then have the progress assessment tool prepare a summary score card using “Create Summary” button 410 located on activity bar 401, thus providing the user with a user view of a summary scorecard page.

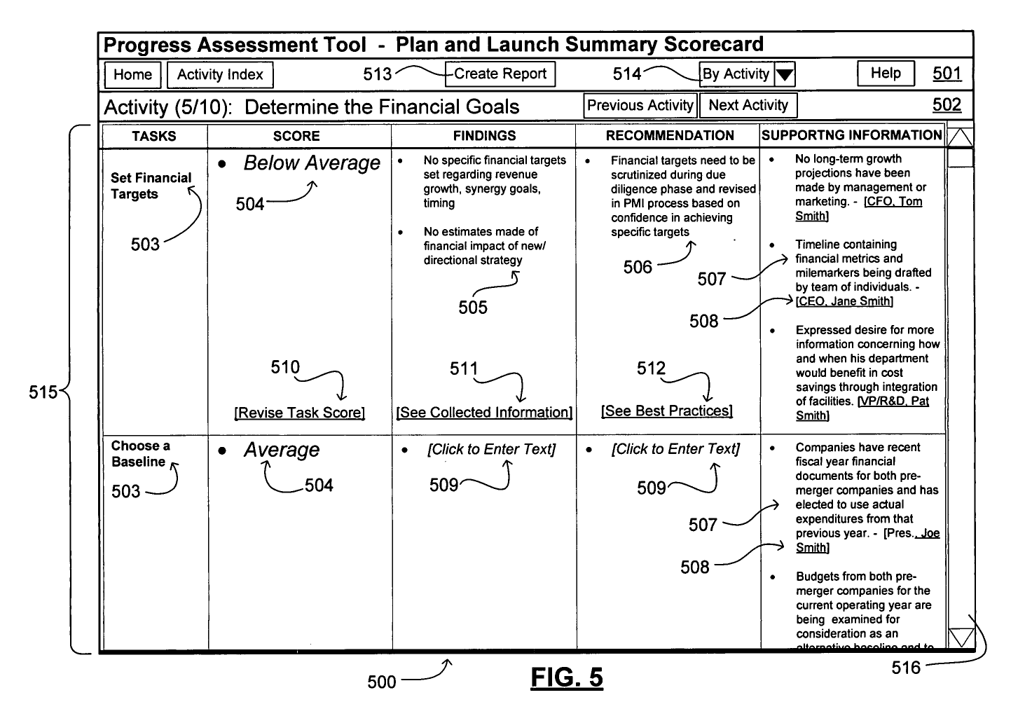

FIG. 5 provides an illustration of a summary scorecard page 500 that serves as an interface within the progress assessment tool that a user may employ to compile a summary scorecard according to the present invention. Summary Scorecard page 500 includes a navigation bar 501, which contains various navigation buttons and any suitable menus (not shown) as are known in the art, and an activity bar 502, which contains a description of the particular activity currently being displayed within the view (i.e., “Activity (5/10): Determine the Financial Goals”). The body of page 500 that comprises the summary scorecard itself is in the form of a table 515 containing five columns and a sufficient number of rows to accommodate each task associated with the activity in question. A scroll bar 516 can optionally be provided along the right hand side of the window to enable a user to completely review all the tasks and information relating to that activity as necessary in the manner known in the art.

The first column to the left side of the summary scorecard table 515 includes a listing of the tasks 503 that fall under the particular activity in question. Working from the left, the second column provides the assigned final score 504 for each task. This final score is automatically provided by the progress assessment tool and corresponds to the final score assigned by the user previously using the detailed scorecards as described above. Underneath each final score 504, the table provides a user with a hyperlink 510 that would allow the user to return to the appropriate detailed scorecard for that activity and task and review the details that produced the assigned final score and, if necessary or desired, to change the final score. The third column in the table permits the user to enter a list of summary findings 505 pertaining to each task 503. Text can be typed in or copied into the appropriate cell in the table by the user as summary findings 505 are not auto-populated into table 515. When initially generated, the summary scorecard table 515 contains blank entries in this column with a placeholder 509 allowing the user to click upon it and enter appropriate text as desired. Under each cell in this column, the user is also provided with a hyperlink 511 by which they could view (such as via a pop up window) all of the entries representing the collected information and data deemed to be relevant to the task in question. As such, the user could decide upon appropriate language to include in the findings, or even copy or cut and paste selected text directly from the entries into the findings.

The next column in table 515 includes recommendations 506 for each task 503. Again, as with the findings 505, recommendations 506 are not automatically populated into the summary scorecard. Summary scorecard page 500 likewise provides the user with the ability to enter any desired text as a recommendation in place of placeholder 509. Additionally, each recommendation cell within the table includes a hyperlink 512 which provides the user with the ability to access relevant best practices narrative records pertaining to the particular task in question, which records are located in an electronically accessible best practices library. This best practices library is discussed in further detail below with respect to FIG. 6.

The final column in the summary scorecard table includes a listing of supporting information relating to the score for each task 503. This supporting information includes any statements or findings entries 507 selected in the underlying detailed scorecard (via selection circles 406) for inclusion in the summary scorecard. As was the case for the detailed scorecard, the summary scorecard also reproduces a source citation 508 for each entry 507. This source citation 508 could allow the user to review the underlying documentation for the particular information in a manner similar to hyperlink 412 described immediately above with respect to the detailed scorecard page 400.

In order to provide flexibility to the summary scorecard page, navigation bar 501 includes a drop down selection window 514 that allows the user to change the manner by which the tasks are sorted and grouped. This menu, for example, could provide options of “By Activity” and “By Score.” In the embodiment depicted in FIG. 5, the option “By Activity” is selected, which automatically groups tasks together by the activity to which they pertain in the format illustrated. By selecting the “By Score” option from selection window 514, tasks could alternatively be grouped, and thus displayed in page 500 in a new table, with task rows being grouped by final assigned score. This alternative view would, of course, require new navigation buttons allowing the user, for example, to toggle between pages illustrating tasks grouped according to different final scores. With this alternative grouping, users could review and concentrate upon all of the Below Average scored tasks for the current progress assessment at a single time.

Navigation bar 501 further includes a “Create Report” button 514 that enables the user to create one or more reports, including in electronic and hard copy (printed) format, reflecting information contained in any of the scorecards in the current progress assessment. Preferably, the create report function initiated by button 514 would permit the user to select whether the report is printed or exported to an electronic format (such as a known word processor document format), and to select what information is provided, and how that information is laid out. For example, the user could select that a report is created from the all the summary scorecards for the present progress assessment, where all summary scorecard tables (e.g., table 515 in FIG. 5) are printed out in order for each activity of the phase in question as defined by the appropriate scorecard template. Thus, a complete summary scorecard paper report could be produced, such as for review by members of the integration management team. Alternatively, the user could select that a report in the form of a word processor file be created from the summary scorecard information for only those tasks that have “Below Average” final scores. The word processor file could later be opened and edited by the user to prepare internal reports, presentations, and the like as desired in order to communicate the findings of the current progress assessment.

The use of the electronic assessment tool according to preferred embodiments of the present invention to prepare various score cards and reports having been described above, description will now be provided with respect to the utilization of a best practices library according to preferred embodiments of the present invention. Referring now to FIG. 6, there is depicted a user view of a best practices library page 600 which contains a navigation window 602 located on the left side of the page 600 and an information display window 603 located on the right side of page 600. Library access page 600 further includes a navigation bar 601 located near the top of the page which includes various buttons and drop down menus (not shown) for navigating within the progress assessment tool. Within navigation window 602, the user is provided with a plurality of links 605 to best practice narrative records that correspond to each activity for each phase. As depicted in FIG. 6, the best practices library records are organized in window 602 underneath headings 604 for their respective phases (i.e., plan and launch, integration program). In page 600, the particular link “Establish a communication plan and process” within window 602 has been selected by the user, causing the display in window 603 of the relevant narrative record for that activity, which record was stored in the database of the best practices library.

The information provided in window 603 would typically appear as a document containing various sections, and optionally having hyperlinks embedded within the document for reviewing additional related information. As depicted in FIG. 6, the document 606 preferably includes a table of contents portion 607 identifying various sections of the document, and optionally providing a mechanism (such as by hyperlinking) for jumping directly to a particular desired section of the narrative record document. A user can scroll down and review relevant portions of the document 606 using scroll bar 609 to obtain summary information regarding the best practices associated with performing the task in question. These best practices records can include, as necessary, sections devoted to particular industries or types of mergers. In this manner, users can be provided with more focused information from which to provide recommendations or constructive criticisms for improving integration progress.

Optionally, within document 606, the user can be provided with one or more hyperlinks 608 to case studies relevant to the activity in question. Preferably, these case studies illustrate real world examples regarding how companies have handled performance of that task in the past, how certain pitfalls can be avoided, and how below average performance can be improved. Preferably, case studies represented in the best practices library are selected so as to adequately reflect a representative cross-section taken from important industries and to illustrate inherent differences in the proper performance merger integration activities necessitated by different merger transaction types. In this manner, a broader sample of narrative records can be provided that is more likely to provide useful information in any given circumstance.

As described above, users can access and review the contents of the best practices library in order to obtain information for summary scorecards and to prepare reports regarding the same. A user could reach document 606 on page 600, for example, by selecting hyperlink 512 on summary scorecard page 500 or by navigating from navigation home page 200 and then selecting a hyperlink for particular narrative records of interest. Preferably, users are also able to search the narrative records and case studies from page 600 (e.g., by accessing a search function of the assessment tool by selecting “Search” button 610), such as for keywords or text strings, in order to locate records of interest.

Upon finding the information sought, the user could “copy” that information and then return to the summary scorecard page to “paste” the copied information into the appropriate cell of a summary scorecard (or into a progress report document being edited in a separate word processing program). Alternatively, the user could export the whole narrative record, or its related case studies, from the library in an electronic file format using an “Export” function button 611. In this manner, the information contained in the narrative records and case studies could be effectively utilized by persons performing progress assessments to provide the fast, targeted, and constructive feedback to managers of the merger integration effort.

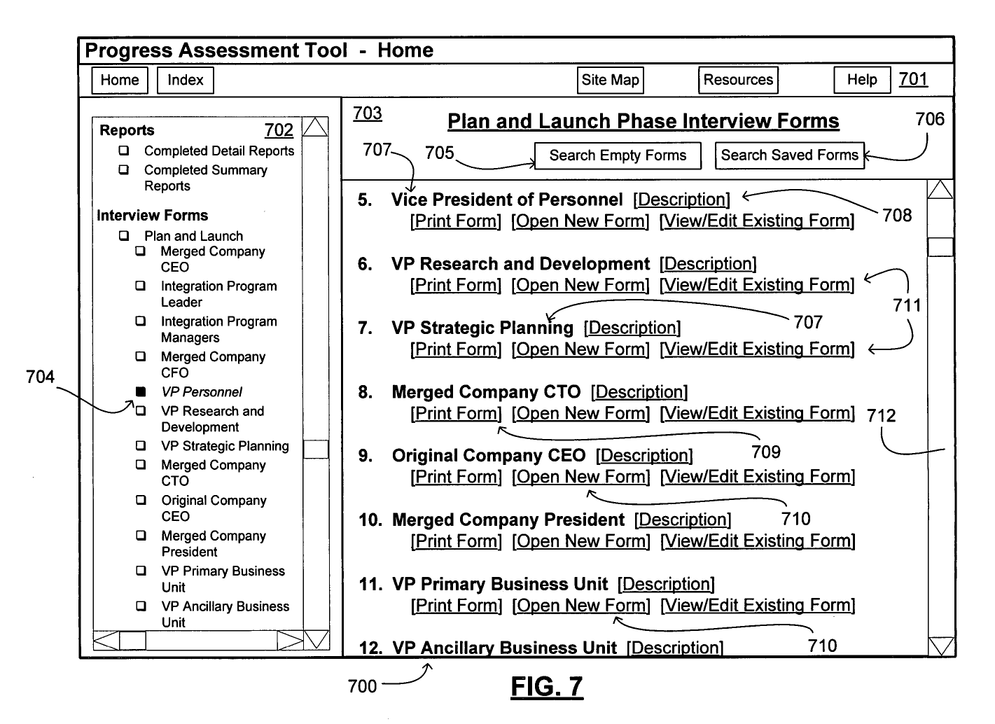

In additional preferred embodiments of the present invention, the electronic assessment tool further includes an interview module that assists users in obtaining information and data from the merged organization and inputting that information into the assessment tool for the creation of detailed scorecards as described above. FIG. 7 illustrates a user view of an interview form selection interface page 700 provided by the interview module of an electronic assessment tool according to preferred embodiments of the present invention. The interview module of the assessment tool contains a database of different interview forms, each form adapted to provide questions that elicit information and data relevant to performing a progress assessment from a given source at a given time.

Referring to FIG. 7, interview form selection page 700 contains a navigation window 702 located on the left side of the page 700 and an interview form selection window 703 located on the right side of page 700. Selection page 700 further includes a navigation bar 701 located near the top of the page which includes various buttons and drop down menus (not shown) as is known in the art for navigating within the electronic progress assessment tool. Within navigation window 702 in the manner as described above with respect to page 200, the user is provided with a plurality of links 704 to various interview forms. The links can be grouped and listed in window 702, for example, according to the title of the person being interviewed (or job description) and the time frame (e.g., phase of the post-merger integration or number of days/weeks/months after the merger was begun) for which the forms are relevant.

It should be readily apparent to one skilled in the art that different information and data will be needed to perform a progress assessment at different times during the life cycle of a post-merger integration. Also, it should be apparent that different types of information and data are available from different sources (i.e., persons) within the merged organization and the original organizations. For example, higher level management officials (CEO, President, etc.) would be more likely to know organization-wide, higher level goals and decisions than mid-level management (such as vice presidents and team leaders/senior managers). Similarly, a vice president in charge of a particular business unit or department, such as R&D, would be more likely to know details regarding the timeline for integrating the operations of the two corresponding groups within the original organizations into a single, newly-merged business unit. Accordingly, different interview forms are contained within the interview module database, which forms vary by containing questions crafted for persons having different titles or functions (e.g., team leader, CEO of the merged organization, VP of a business unit from one of the pre-merger organizations, etc.) who might be interviewed. Each form contains questions particularly targeted to elicit relevant information from a person serving the function or holding the position in question. Additionally, different forms for each particular position/function are preferably provided such that interview questions can be more accurately targeted to assessing the progress during the appropriate time period (i.e., the questions that should be asked of the CEO during the integration program phase would be different than the questions for the plan and launch phase). By selecting the appropriate form for a given interviewee, according to both position/function and interview time frame, the interviewer utilizing the interview module can be certain to obtain the most relevant information and data from the best sources for the particular time period during which the progress assessment is being performed.

As depicted in FIG. 7, the database of interview forms can be organized, for example, in navigation window 702 underneath headings for the phases (i.e., plan and launch, integration program) for which those forms are directed, and then named descriptively to identify the person (according to title or function) targeted by the form. In page 700, the particular link “VP Personnel” within window 703 has been selected by the user, causing the displayed list of form names 707 in selection window 703 to jump to the corresponding form name in the list. This list displayed in selection window 703 contains the names of various different interview forms contained in the interview module database that are adapted to elicit information relevant to performing a progress assessment during the plan and launch phase of post-merger integration. Similar lists for other phases or time periods of interest could likewise be made accessible and accessed via navigation window 702 in similar manner.

The list of form names 707 available for the selected phase can be browsed in selection window 703 by, for example, using scroll bar 712 or similar means as is known in the art. Once a desired interview form name 707 that is potentially suitable for the interviewee (having a known job title or function) is identified, the user is provided with four options that are selectable via one of four hyperlinks 708-711 associated with each form name 707.

A first option, to view a text description of the use and purpose of the form in question, is provided by hyperlink 708 (“Description”). Selection of hyperlink 708 would provide the user with a description regarding the underlying form for that form name, which description would assist the user in deciding whether that particular form would be suitable for the interviewee in question. The description, for example, could describe generally what types of information and data the form is designed to obtain and to which post-merger integration activities and tasks this information and data is relevant. A search function, made accessible via button 705 (labeled “Search Empty Forms”) in the depicted embodiment, would allow a user to search the description of the forms and/or the form's questions, such as for matches to entered keywords or text strings, in order to identify interview forms that may be suitable for a potential interviewee.

The second option, provided by hyperlink 709, allows the user to print out an empty copy of the particular interview form in full hard copy format. This would allow the user, for example, to provide the form to the user to fill out, to take the form with them to use as a list of questions to reference and ask during a verbal interview, or otherwise to read the questions presented and information/data sought by the form.

The third option, selectable via hyperlink 710, allows the user to open the corresponding interview form for creation of a new interview record file. Selecting hyperlink 710 would provide the user with a suitable electronic form interface, such as that described specifically below with respect to FIG. 8, to input various answers (including findings or statements entries 405 as described above) to questions presented in the form into an electronic interview record file. This interview record file can thereafter be utilized by the electronic assessment tool according to these preferred embodiments to compile finding and statement entries reviewable through different detailed scorecard pages (as described above) once all information and data gathering has been completed. An example of a interview form input page 800 containing questions and enabling data/information entry responses is described below with respect to FIG. 8.

The fourth option, selected with hyperlink 711, permits the user to open for editing or review an existing (i.e., previously entered or saved) interview record file. This option, for example, would be useful where a user wanted to update the interview record for an earlier interview, or where the user was conducting a follow-up progress assessment at a later time and wanted to create a new interview record for the same interviewee (thus saving the need to re-enter duplicative biographic and/or background data or any similar answers to the form's questions). A search function of saved interview record files is provided by button 706 (named “Search Saved Forms” in the depicted page 700), which could allow the user to locate previous interview records using common file searching techniques known in the art.

FIG. 8 illustrates a user view of a interview form input page 800 provided by an electronic assessment tool according to one particular preferred embodiment of the present invention to allow a user to create, save, review and revise interview record files. Interview form input page 800 contains an input window 801 located beneath a navigation and menu bar 801 located near the top of the page, which bar includes various buttons and drop down menus (not shown) as is known in the art for navigating within various pages and windows of a software tool. The body of the input form in question is displayed within the input window 802, and this form can be navigated as is known in the art (such as with scroll bar 803, as depicted). The top of the form contains an identifier 804 of the form type being displayed, preferably identifying the form according to both the time period (“Plan and Launch Phase”) and the title/function of the interviewee (“VP, Personnel, Merged Company”) for which the form is intended. Just below the identifier 804 is a pull-down selection box 805 to allow the user to associate the current form with an existing project assessment project, or to create a project assessment project name if a new project assessment project is being begun. Selection box 805 thereby allows the user to associate many different interview record files together for purposes of reviewing and preparing detailed and summary scorecards.

Each form, including the one displayed in input window 802 of FIG. 8, includes a biographic and background data section 806 that includes various text input boxes 806a-806f that allow the user to enter information to identify the interviewee. This biographic and background data could include, for example, the name and title of the interviewee as well as the interviewee's contact information.

Each form also comprises a question and topic section 807 (the majority of question and topic section not being depicted in FIG. 8 as it could be seen by utilizing scroll bar 803 to scroll downward), which includes a plurality of interview questions or topics 808 relevant to the time period of the progress assessment and title/function of the interviewee. The questions and topics for each particular form are only included in a given form if they will elicit the type information from the target person that would be useful in performing the progress assessment in that particular time period of post-merger integration. Each question or topic presented on each interview form is associated with one or more tasks contained in the activity scoring tables, where each question is expected to obtain information relevant to evaluating the scoring criteria for the particular associated tasks.

Each question or topic 808 within an interview form can require open-ended qualitative answers or quantitative answers, or can require that answers be selected from multiple provided choices. As depicted in FIG. 8, a single topic can allow for multiple open-ended answers by providing several text entry boxes 809 below the statement of the question or topic 808. These text boxes can be used to, for example, paraphrase statements made by the interviewee that are relevant to the topic, quote direct answers from the interviewee, and list examples or figures provided by the interviewee. Thus, more than one statement or finding entry (such as element 405 of FIG. 4 above) can be generated as an answer for each question or topic 808. In the event that additional text boxes are desired, the user could have the page dynamically create one, such as by selecting the “More” hyperlink 810 located at the bottom of the provided text boxes 809. For questions or topics that require answers to be selected from multiple provided choices, pull-down selection boxes (similar in operation and function to selection box 805) or selection circles (similar in operation and function to selection circles 407) can be employed to provide the user/interviewee with the available choices.

After a given interview input form is completed, an interview record file can be created using the “Save Form” button 811 located on menu bar 811. The resulting interview record file will contain the data and information entered into the input form and will be stored in a location accessible by the electronic assessment tool for later compilation and construction of detailed scorecards, summary scorecards, and reports as described above. Users can also re-open previously saved interview record files using the “Open Form” button 812 on menu bar 801 in order to review and revise those files as desired.

In this manner, the responses for various interviewees to various tailored questions and topics can be input electronically into interview record files that are usable by the electronic assessment tool. Since the questions and topics presented on each interview input form are associated with one or more of the tasks (which tasks are defined by the activity scoring tables of the appropriate scorecard template), the answers provided on the various forms can be automatically correlated by the electronic progress assessment tool with the associated tasks to produce statement and findings entries 405 for later consideration during review of detailed scorecards. Appropriate information from various sources can therefore be automatically accumulated, attributed and organized into relevant portions of a detailed scorecard by the scorecard generation module. The user can then review this detailed scorecard to see an overview of collected and organized information potentially relevant to each integration activity and task, and more easily consider the scoring criteria for each task.

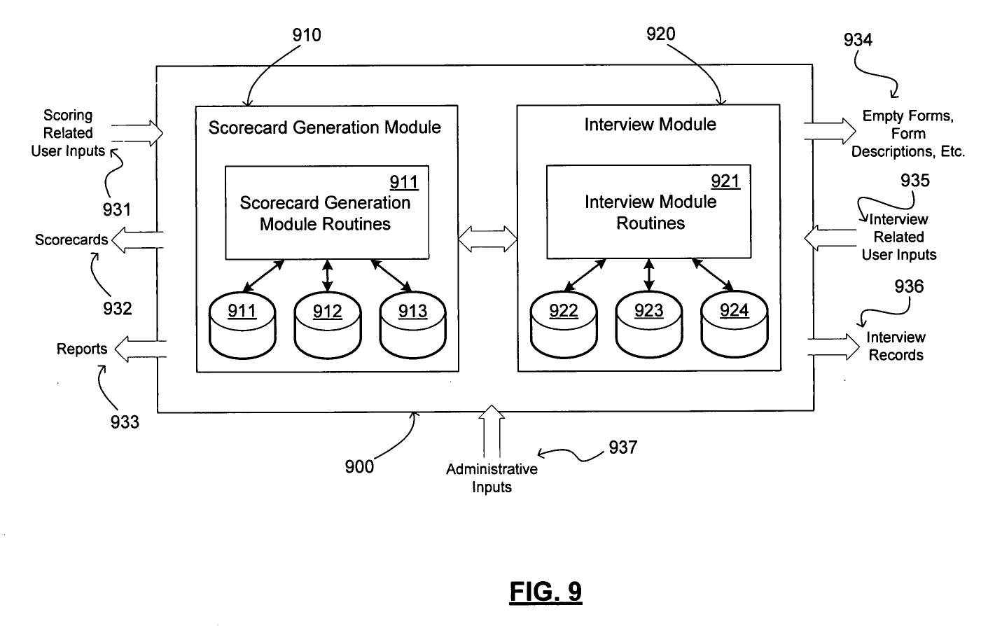

The general functional operation of the electronic tools according to preferred embodiments of the present invention having been thus described, FIG. 9 schematically illustrates a system 900 embodying an electronic assessment tool according to preferred embodiments of the present invention. As depicted in FIG. 9, the system 900 may include various software-driven applications and routines that comprise modules to automatically perform various steps of associated with the preparation of progress assessments as described above. Specifically, system 900 may include two software driven modules 910 and 920 that operate in electronic communication, a scorecard generation module 910 and an interview module 920.

The scorecard generation module 910 contains a set of routines 911 that prepare the interface pages and perform the steps and operations with respect to the review and compilation of scorecards substantially as described above. These routines are in communication with three accessible databases, including a scorecard template database 912 (containing the defined scorecard templates and their constituent scoring tables), a best practices guidelines database 913 (containing the library of best practices narratives and case studies), and a scoring results database 914. The scoring results database 914 is adapted to store all of the scoring decisions reflected by the various scoring related inputs 931 from the user, including any compiled detailed scorecards, summary scorecards and the like. In this manner, the user can access particular scorecards at later times to make changes, create reports, and the like. As described above, the primary outputs of the scorecard generation module 910 are scorecards 932 (whether printed or viewed) and reports (both printed and electronic).

Likewise, the interview module 920 contains a set of routines 921 that prepare the interface pages and perform the steps and operations relating to the review and utilization of interview forms substantially as described above. These routines are also in communication with three accessible databases, including an interview forms database 922 (containing the various interview forms corresponding to each scorecard template), an association rules database 923, and an interview records files database 924. The interview records files database 924 is adapted to store all of the interview records files created (and modified) using the interview module as described above. Thus, the user can access any desired interview records files stored in database 924 for review or modification at later times. The association rules database contains a mapping that defines, for each question or topic in a given interview form, to which tasks any answers for those questions/topics should be automatically associated by the tool.

As described above, the primary outputs 932 of the interview module 920 are empty forms, form descriptions, and the like which are provide both in electronically displayed form and printed form. The interview module 920 can also optionally output interview records 936, such as in printed or electronic format, for review outside the electronic assessment tool or for editing using an external word processing program for inclusion in reports and the like.

As illustrated in FIG. 9, the scorecard generation module 910 and the interview module are in electronic intercommunication, allowing the electronic assessment tool to operate seamlessly. The two modules will pass data back and forth to each other as necessary to achieve the steps necessary to produce assessments and scorecards, including the automated passing of data concerning statements and findings entries for utilization in the generation of detailed scorecards. The entries could be derived as needed by the interview module 920 from the association rules and the interview records files upon request by the scorecard generation module and would contain the latest information reflected in databases 923 and 924.

Additionally, system 900 would preferably include an administration inputs interface 937 that would allow a user to review and update the operations of the electronic assessment tool. Administrative functions supported by interface 937 could include the ability to review and update the scorecard templates and associated scoring tables utilized by the scorecard generation module 910 and the association rules and interview forms utilized by the interview module 920.

As will be readily understood by one of ordinary skill in the art, system 900 is meant to be illustrative of one design architecture that would support the operation of the electronic tools according to the present invention. Thus, the particular system elements illustrated, including the number and relationship of the various databases and routines, could be modified in various insubstantial ways while still providing an electronic assessment tool according to the present invention.

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols and user interface conventions as they are developed. It is intended that the scope of the invention be limited not by this detailed description, but rather by the claims appended hereto.

1. An electronic tool adapted to facilitate the performance of assessments regarding the progress of integration efforts intended to further a merger or acquisition involving a target company, said tool comprising:
a template database containing at least one scorecard template that reflects a plurality of integration activities that must be addressed during said integration efforts, each said scorecard template including a plurality of scoring tables with each said scoring table corresponding to a particular one of said integration activities, each said scoring table providing scoring criteria for one or more tasks that underlie a corresponding one of said integration activities, said scoring criteria providing a description of indicators that correlate to a plurality of scoring levels within which each task can be rated, said criteria reflecting industry or business standards; and
a scorecard generation module having software operable to utilize said template database to prepare progress assessments, said scorecard generation module permitting a user to select a scorecard template from said database, review associated scoring tables that comprise said selected scorecard template, and generate a scorecard reflecting appropriate scoring levels for activities defined by said selected scorecard templates and said associated scoring tables;
wherein said scorecard generation module allows a user to review different scoring criteria entries for the scoring levels of each task in said associated scoring tables and compare those entries with data concerning the current status of said target company, rate each task in said associated scoring tables into an appropriate one of said scoring levels in light of said scoring criteria, and prepare a scorecard describing scoring level ratings.

2. The electronic tool according to claim 1, wherein said template database contains a plurality of said scorecard templates, each scorecard template reflecting a plurality of integration activities that are particularly relevant within a phase of said integration efforts, wherein different ones of said scorecard templates are selectable for performance of assessments during different phases of said integration efforts.

3. The electronic tool according to claim 2, wherein said phases include at least a plan and launch phase and an integration program phase.

4. The electronic tool according to claim 3, wherein said phases further include a pre-merger or pre-acquisition phase.

5. The electronic tool according to claim 1, wherein each scoring table defines four scoring levels correlating to judgments of below average progress, average progress, above average progress, and excellent progress.

6. The electronic tool according to claim 1, wherein said scoring criteria indicators can be of types selected from the group consisting of qualitative standards, quantitative standards, and combinations thereof.

7. The electronic tool according to claim 1, wherein said scoring criteria and scoring levels reflect progress judgments in light of industry or business standards as determined by the collective expertise of one or more specialists with experience in merger or acquisition integration efforts.

8. The electronic tool according to claim 1, further comprising a forms database, said forms database containing a plurality of interview forms for accumulating data regarding the progress of said target company, each said interview form containing questions that are customized according to a type or category of target person to be interviewed and associated with a particular scorecard template in said template database, and wherein each question on any particular interview form is associated with one or more tasks contained in particular scoring tables in said template database to indicate that said associated question is expected to be answered with information that is relevant to evaluating particular scoring criteria for the associated tasks.

9. The electronic tool according to claim 8, further comprising an interview module having software operable to utilize said interview forms in said forms database, said interview module permitting a user to access and select desired interview forms and enter data obtained during interviews as answers to questions in said selected interview forms.

10. The electronic tool according to claim 9, wherein said entered data is stored and automatically correlated by said interview module and said scorecard generation module to prepare a detailed progress assessment scorecard according to a selected scorecard template; said detailed scorecard identifying for each scoring table portions of said entered data that is relevant to evaluating particular scoring criteria for each task that must be rated by the user.

11. The electronic tool according to claim 10, further comprising a narratives database containing best practices narratives, and wherein said detailed scorecard can viewed in electronic form using said scorecard generation module, and wherein said electronic detailed scorecard provides links to access to particular best practices narratives that are relevant to rating said tasks.

12. The electronic tool according to claim 10, wherein said tool further includes an interview records database containing entered data corresponding to particular interview records, and wherein said detailed scorecard can be viewed in electronic form using said scorecard generation module, said electronic detailed scorecard providing access via links to complete data for an appropriate one of said interview records from each piece of said relevant data that is displayed in said detailed scorecard.

13. The electronic tool according to claim 10, wherein said detailed progress assessment scorecard presents relevant scoring criteria and said portions of said entered data in table format such that they may compared by the user such that the user can rate each task into an appropriate scoring level.

14. The electronic tool according to claim 10, wherein said scorecard generation module can be adapted to permit summary scorecards to be generated, said summary scorecards displaying scoring level ratings for selected ones of relevant tasks or activities for the progress assessment.

15. The electronic tool according to claim 14, wherein said selected ones of said tasks or activities comprise those tasks or activities that have common scoring level ratings.

16. The electronic tool according to claim 14, wherein said scorecard generation module is further adapted to prepare reports to present data from said summary scorecards in a desired format.

17. The electronic tool according to claim 1, wherein said scorecard generation module is further adapted to prepare reports to present data from said scorecards in a desired format.

18. A method for performing assessments regarding the progress of integration efforts intended to further a merger or acquisition involving a target company, said method comprising:
preparing a plurality of scorecard templates that each reflect a plurality of integration activities that must be addressed during said integration efforts, each said scorecard template including a plurality of scoring tables with each said scoring table corresponding to a particular one of said integration activities, each said scoring table providing scoring criteria for one or more tasks that underlie a corresponding one of said integration activities, said scoring criteria providing a description of indicators that correlate to a plurality of scoring levels within which each task, said scoring criteria reflecting industry or business standards for rating said scoring levels; and
selecting an appropriate one of said scorecard templates, said selected scorecard template being particularly adapted for performing a progress assessment at a desired time, said selected scorecard template being comprised by a plurality of select scoring tables associated therewith, each select scoring table relating to a select integration activity and containing one or more select tasks and select scoring criteria describing said scoring levels for said select tasks;
accumulating data that is relevant to said select scoring criteria for one or more of said select tasks;
correlating said accumulated data with said select tasks, wherein units of said correlated data are matched as appropriate with one or more select tasks to form a compilation of correlated data units for each associated task;
comparing the particular compilation of correlated data units with one of said select scoring criteria for each said select task in each said select scoring table;
rating each said select task in each said select scoring tables into an appropriate one of said scoring levels in light of said comparing; and
preparing a scorecard describing said scoring level ratings.

19. The method according to claim 18, wherein said plurality of said scorecard templates differ from one another in that each scorecard template reflects a plurality of particular integration activities that are particularly relevant within a phase of said integration efforts, whereby different ones of said scorecard templates can be selected to perform a progress assessment during different phases of said integration efforts.

20. The method according to claim 19, wherein said phases include at least a plan and launch phase and an integration program phase.

21. The method according to claim 20, wherein said phases further include a pre-merger or pre-acquisition phase.

22. The method according to claim 18, wherein each scoring table defines four scoring levels correlating to judgments of below average progress, average progress, above average progress, and excellent progress.

23. The method according to claim 18, wherein said scoring criteria indicators can be of types selected from the group consisting of qualitative standards, quantitative standards, and combinations thereof.

24. The method according to claim 18, wherein said scoring criteria and scoring levels reflect progress judgments in light of industry or business standards as determined by the collective expertise of one or more specialists with experience in merger or acquisition integration efforts.

25. The method according to claim 18, wherein said scorecard templates and scoring tables comprise electronic files, and wherein said selecting of said appropriate one of said scorecard templates is performed with the assistance of software.

26. The method according to claim 18, further comprising:
preparing a plurality of interview forms adapted to provide direction to a user in the accumulating of data regarding the progress of said target company, each said interview form containing questions that are customized according to a type or category of target person to be interviewed and associated with a particular one of said plurality of scorecard templates, and wherein each question on any particular interview form is associated with one or more tasks contained in particular scoring tables in said template database to indicate that said associated question is expected to be answered with information that is relevant to evaluating particular scoring criteria for the associated tasks; and
wherein said accumulating data comprises utilizing said interview forms to conduct an interview with an appropriate target person and obtaining data in the form of answers by said target person to said questions in said selected interview forms.

27. The method according to claim 26, wherein said accumulated data is stored and automatically correlated by a software program to prepare a detailed progress assessment scorecard according to said selected scorecard template; said detailed scorecard identifying for each scoring table portions of said accumulated data that is relevant to evaluating particular scoring criteria for each task that must be rated.

28. The method according to claim 27, wherein said preparing of a detailed scorecard comprises providing citations to access to particular best practices narrative records that are relevant to rating said tasks.

29. The method according to claim 27, further comprising using said software to store said accumulated data in a database of interview records, and wherein said detailed scorecard can contain citations to a full interview record for each piece of said relevant data that is contained in said detailed scorecard.

30. The method according to claim 27, wherein said detailed progress assessment scorecard presents relevant scoring criteria and said portions of said entered data in table format such that they may compared by the user such that the user can rate each task into an appropriate scoring level.

31. The method according to claim 27, further comprising generating a summary scorecard that displays scoring level ratings for selected ones of relevant tasks or activities for the progress assessment.

32. The method according to claim 31, wherein said selected ones of said tasks or activities comprise those tasks or activities that have common scoring level ratings.

33. The method according to claim 18, further comprising updating said plurality of scorecard templates to reflect changes in said industry or business standards.
